(19) United States
(12) Patent Application Publication
(10) Pub. No.: US 2013/0343849 A1
(43) Pub. Date: Dec. 26, 2013

(54) Method and Apparatus for Lifting and Transporting Exercise Equipment

(71) Applicant: Kim Jason Joseph Gobert, Winnipeg (CA)

(72) Inventor: Kim Jason Joseph Gobert, Winnipeg (CA)

(21) Appl. No.: 13/923,765

(22) Filed: Jun. 21, 2013

Related U.S. Application Data
(60) Provisional application No. 61/663,786, filed on Jun. 25, 2012.

(51) Int. Cl. B60P 1/54

(52) U.S. Cl. CPC B60P 1/5438
USPC 414/540; 254/324; 414/800; 414/812

(57) ABSTRACT

An apparatus and method for lifting and transporting exercise equipment features use of a winch movably supported on a header spanning between a pair of wheeled side frames for adjustment of the winch position in two dimensions to account for varying center of gravity locations on different pieces of equipment to be lifted. The apparatus is rolled into a position straddling the equipment for lifting of same, at which time supports are laid across the space between the side frames for lowering of the equipment onto the supports for stable seated transport of the equipment on the supports by rolling of the wheeled apparatus. A single service technician can easily and safely remove a piece of equipment from the exercise floor to avoid disruption or hazard to gym members.

This application claims benefit under 35 U.S.C. 119(e) of provisional application Ser. No. 61/663,786, filed Jun. 25, 2012.

### FIELD OF THE INVENTION

The invention relates generally to lifting equipment, and more particularly to lifting equipment and methods adapted for lifting and transporting treadmills, elliptical machines or other exercise equipment of notable bulk and weight out, for example, out of a row of such equipment at an exercise facility.

### BACKGROUND OF THE INVENTION

Many pieces of cardio equipment at a gym need regular maintenance. Performing service work on cardio equipment on the exercise floor is difficult and impractical, as there may be wires and tools scattered around, and the noise from the drill or vacuum may disturb the customers. Repairs often require lubricant sprays and cleaning solutions, which could pose a problem to those with sensitivities to products with scents. Also, the lighting on a gym floor is not ideal for working on small parts. Ideally, the work should be done in a designated work area, but it can be difficult for one repair technician to move the equipment by himself or herself due to the weight, size and awkward shape of such equipment.

Off the shelf dollies or hand trucks are typically unsuitable to accommodate the bulky size and shape of such equipment, and additionally would require manual lifting or tipping of the heavy equipment, presenting notable risk of injury to the technician and/or damage to the equipment.

Off the shelf hoists intended for other equipment handling applications, for example engine hoists, are also unsuitable to address equipment handling needs in an exercise facility, for example due to the unsuitability for such equipment to access a particular machine from among a row of closely spaced machines in a common gym layout.

Accordingly, an effective and safe solution is needed for lifting and transport of exercise equipment to allow maintenance, service and repair of such equipment with minimal disruption on the exercise floor of the facility.

### SUMMARY OF THE INVENTION

According to a first aspect of the invention there is provided an apparatus for lifting and transporting exercise equipment, the apparatus comprising:

a pair of side frames each comprising wheels at a bottom thereof;

a header joining together the pair of side frames;

a winch supported by the header for lifting of said exercise equipment.

Preferably the winch is supported on the header in a manner movable in both side-to-side and front-to-back directions to accommodate varying center-of-gravity locations of different pieces of exercise equipment to enable balanced lifting of said different pieces of exercise equipment.

Preferably the header is adjustable in height.

Preferably there are provided supports for placement under the exercise equipment when lifted for lowering of the exercise equipment onto the supports to prevent swinging of the exercise equipment during transit.

Preferably there is provided a lift unit that lowerable by the winch and positionable under lift points of the exercise equipment for lifting thereof.

Preferably there is also provided a different second lift unit.

Preferably each lift unit is adjustable.

One of the lift units preferably comprises a longitudinal lift member.

Preferably there are front and rear transverse lift members lying perpendicular to the longitudinal lift member.

Preferably there are lift point members projecting longitudinally from the front transverse lift member to extend away from the longitudinal lift member on opposing sides thereof.

Preferably the lift point members are adjustable in position along on the front transverse lift member.

Preferably the lift point members are padded.

Preferably there is provided a cradle unit attached to the rear transverse member for engagement of a lower end of said cradle unit under a rear end of the exercise equipment to suspend said rear end of the exercise equipment from said rear transverse member.

Preferably the longitudinal lift member comprises a series of different attachment points spaced therealong for selective connection of the winch to the longitudinal member at any of said attachment points.

Preferably the longitudinal lift member is adjustable in length.

Preferably the winch is supported on the header in a manner movable in both side-to-side and front-to-back directions, each side frame comprises an elongated base running defining a longitudinal front to back direction of the apparatus and the wheels of each side frame are attached to the elongated base of said side frame at spaced apart positions along the longitudinal front to back direction of the apparatus, the header comprises header beams defining a lateral side-to-side direction of the apparatus and spacing the side frames horizontally apart in said lateral side-to-side direction, and the apparatus is rollable in the longitudinal direction on the wheels to place the side frames on opposing sides of the exercise equipment with the header beams spanning over the exercise equipment in the lateral direction to place the winch overhead of the exercise equipment, whereby a location of the winch in relation to the center of gravity is adjustable in the longitudinal direction by both rolling of the apparatus and movement of the winch in said the longitudinal direction and adjustable in the lateral direction by movement of the winch in said lateral side-to-side direction.

Preferably each side frame comprises a pair of uprights upstanding from the elongated base at spaced apart locations in the longitudinal direction and at least on cross-member joining the pair of uprights together at a height spaced upwardly from the elongated base, and the header beams join together the uprights of the side frames in respective pairs.

Preferably the wheels of each side frame comprise front and rear wheels each located outward from the pair of uprights in the longitudinal direction.

Preferably there is provided a carrier member on which the winch is mounted, the carrier member being movably supported on an elongated track extending in either the front-to-back or side-to-side direction for back and forth movement of said carrier member along the elongated track, and the elongated track being movable back and forth relative to the side frames in the other of the front-to-back or side-to-side direction.

Preferably the winch is positioned at an elevation below that of each header beam.

Preferably there is provided a flexible strap operably wrapped on the winch for deployment and retraction of said flexible strap by the winch.

Preferably the winch is adapted for driven operation thereof by a portable electric drill.

According to a second aspect of the invention there is provided a method of lifting and transporting a selected piece of exercise equipment from among a row of multiple pieces of exercise equipment placed side by side on the ground or floor of an exercise site, the method comprising:

(a) rolling a lift apparatus into a position straddling said selected piece of exercise equipment with two side frames of said lift apparatus on opposing sides of said selected piece of exercise equipment and a header of said lift apparatus spanning over said selected piece of exercise equipment from one of said side frames to the other;

(b) using a winch carried by said header of the lift apparatus, lifting the selected piece of exercise equipment off of the ground or floor from overhead of said selected piece of exercise equipment; and

(c) with the selected piece of exercise equipment supported by said lift apparatus at a position between the side frames of the apparatus and above the ground or floor of the exercise site, rolling the lift apparatus out of a position from which the selected piece of exercise equipment was lifted so as to withdraw said selected piece of exercise equipment from the row of said multiple pieces of exercise equipment.

Step (b) may first comprise adjusting a location of the winch relative to the side frames toward a center of gravity of the selected piece of exercise equipment before lifting thereof.

Step (b) may comprise adjusting the location of the winch in two horizontal dimensions.

The method may comprise changing a type of exercise equipment the apparatus is adapted to lift by swapping out one style of lifting unit suspended from the winch for another style of lifting unit.

Step (b) may comprise lifting the selected piece of exercise equipment with a lifting unit that is carried by the winch and engages the selected piece of exercise equipment adjacent two longitudinally opposing ends thereof, in which case step (b) may comprise hooking two lift point members of said lifting unit beneath a pair of shoulders adjacent a front end of an elliptical machine at which arm levers of the elliptical machine are pivotally connected, and engaging a cradle member of said lifting unit around an opposing rear end of elliptical machine.

Alternatively, step (b) may comprise lifting the selected piece of exercise equipment with a lifting unit that is carried by the winch and engages the selected piece of exercise equipment only at a longitudinally intermediate location thereon, in which case step (b) may comprise hooking a transverse bar of the lifting unit under each of two handles of a treadmill machine at respective corners where said handles join to respective upright handle supports that extend upward from a base of said treadmill machine. In such instance, step (b) may also comprise securing a flexible tie around said upright handle supports from adjacent opposing ends of the transverse bar of the lifting unit.

With the selected piece of exercise equipment lifted, step (b) may comprise placing transverse supports in positions spanning between the two side frames beneath the selected piece of exercise equipment, and lowering said selected piece of exercise equipment into a seated position on said transverse supports for seated, rather than hanging, support of the exercise equipment during transit in step (c).

### BRIEF DESCRIPTION OF THE DRAWINGS

In the accompanying drawings, which illustrate exemplary embodiments of the present invention:

FIG. 1 is a perspective view of an apparatus according to one embodiment of the present invention for lifting and transporting exercise equipment.

FIG. 2 is a partial side view of the apparatus of FIG. 1.

FIG. 3 is a partial rear view of the apparatus of FIG. 1.

FIG. 4 is a rear/side perspective view of the apparatus in FIG. 1 in use during transport of an elliptical machine.

FIG. 5 is a side view of the apparatus in FIG. 1 in use during transport of a treadmill machine.

FIG. 6 is a side elevational view of the apparatus similar to that of FIG. 1.

FIG. 7 is a schematic plan view illustrating a positional adjustability of a winch of the apparatus of FIG. 6 in two dimensions.

FIG. 8 is a cross-sectional view of FIG. 7 as viewed along line A-A thereof.

FIG. 9 is a cross-sectional view of FIG. 8 as viewed along line B-B thereof.

FIG. 10 is an overhead plan view of a winch-carried lift unit of the apparatus of FIG. 1.

FIG. 10A is a partial perspective view illustrating a telescopic length adjustment of the lift unit of FIG. 10.

FIG. 10B is a perspective view of a sliding sleeve and locking pin of the lift unit of FIG. 10 for lateral-position adjustment of two lift point members of the unit that hook under suitable lift points on a piece of exercise equipment.

### DETAILED DESCRIPTION

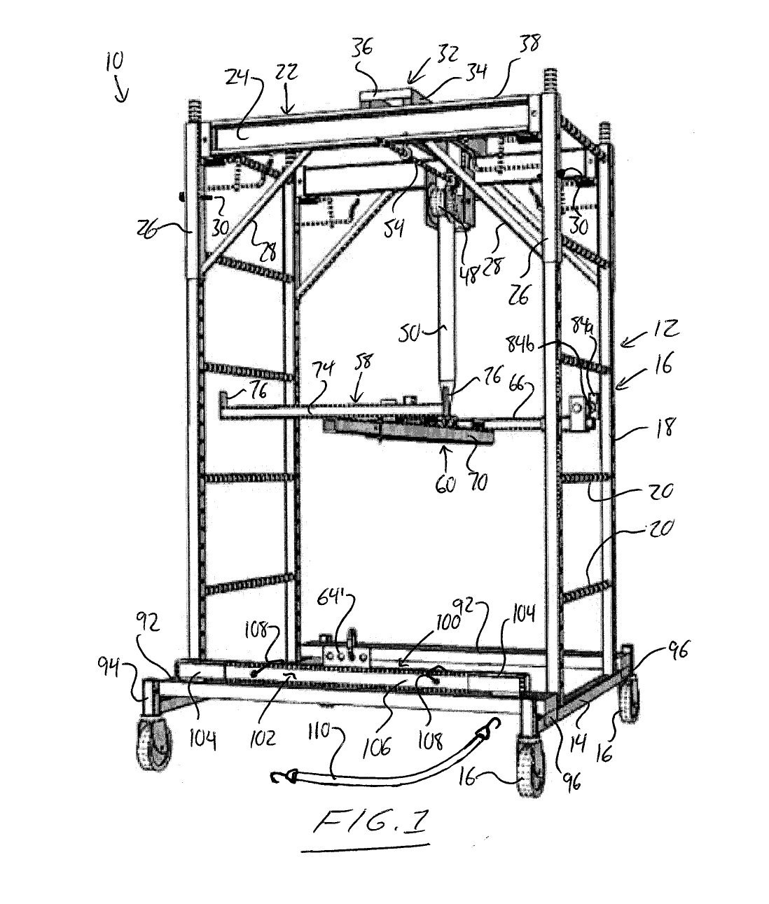

FIG. 1 shows an apparatus according to one embodiment of the present invention for lifting and transporting exercise equipment, including but not limited to treadmills, elliptical trainers, and other cardio-workout equipment. The structure of the illustrated apparatus is detailed herein as follows with particular reference to FIGS. 1 to 3.

The apparatus 10 features two side frames 12 that are horizontally spaced apart in a lateral direction of the apparatus. Each side frame 12 features an elongated horizontal base member 14 running linearly in a longitudinal direction of the apparatus that lies perpendicular to the aforementioned lateral direction. A respective caster wheel 16 is attached to the base member 14 adjacent each end thereof to rollably support the side frame 12. Centered on the length of the base member 14 is a generally ladder-shaped upright structure 16 featuring two vertically upright posts 18 spaced apart along the longitudinal direction, and horizontally joined together in the longitudinal direction at several heights by a set of cross-members 20 forming the ‘rungs’ the generally ladder-shaped form of the upright structure.

A pair of header assemblies 22 join together the two side frames 12 near the upper ends of the upright posts 18. A front one of these header assemblies is attached to the two uprights posts nearest a front end of the side frame base members 14, and a similar or identical one of these header assemblies is attached to the two uprights posts nearest an opposing rear end of the side frame base members 14. As the two header assemblies may be identical, their shared structure is described only in terms of the rear header assembly clearly shown in FIGS. 1 and 3. A header cross-beam 24 spans perpendicularly and horizontally between the two respective uprights posts 18 near the upper ends thereof. A respective channel member 26 is fixed to the cross-beam 24 at each end thereof to embrace around three sides of the respective one of the upright posts from the side thereof that faces outward from the rest of the upright structure in the longitudinal direction. A diagonal brace 28 is fixed between each channel member 20 and the header cross-beam 24 at an oblique angle to aid in retention of the rigid shape of the resulting header assembly 22.

The channel members 26 feature matching sets of through-holes passing horizontally through them in the transverse direction, and there is a matching set of through-holes in each of the respective upright posts over at a location spanning part of the post's length near the upper end thereof. A bolt or lock pin 30 is used at each of the two channel members 26 to pass through a selected hole therein and an aligned hole in the respective upright post in order to set a height at which the header assembly 22 is attached to the pair of upright posts that it joins together. Accordingly, the height at which the two header assemblies 22 are carried on the side frames can be adjusted. Use of an open channel member to embrace, but not fully enclose around, the respective upright post allows one or more of the rung-like cross-members 20 of the frame to be present at or near the top end of the upright posts in order to better maintain a rigid shape of the upright structure of the side frame than if such upper cross-member were absent, but other embodiments may feature an enclosed tubular sleeve instead of an open channel at each end of the header assembly in order to telescopically engage over the top end of the upright in an adjustable manner. Alternatively, a telescopic mating may be achieved by insertion of upright end members of the header assembly into hollow upright posts of the side frames.

A longitudinal track assembly 32 lies atop and spans between the two spaced apart header cross-beams 24 at the front and rear ends of the apparatus. The track assembly extends perpendicularly between the two header cross-beams to provide a horizontally-extending track lying in the longitudinal direction of the frame. The track features two parallel, longitudinal rails 34 that are horizontally spaced apart by a small distance in the lateral direction of the apparatus. At each end, the track 32 is closed off by a respective end piece 36 connecting together the ends of the two rails 34 at a position over the respective header cross-beam 24. An upwardly directed flange 38 of each header cross-beam 24 juts up from an upward-facing surface of the header cross-beam on which the rails 34 are slidably seated, thereby forming a stop to block the rails, and thus the entire rail assembly, from sliding longitudinally off the two cross-beams 24. However, the width of the rail assembly, as measured in the transverse direction of the apparatus, is at a few times less than the length of the cross-beams (as also measured in the transverse direction), whereby the rail assembly is slidable back and forth in the transverse direction to allow side-to-side motion thereof in relation to the side frames and header assemblies.

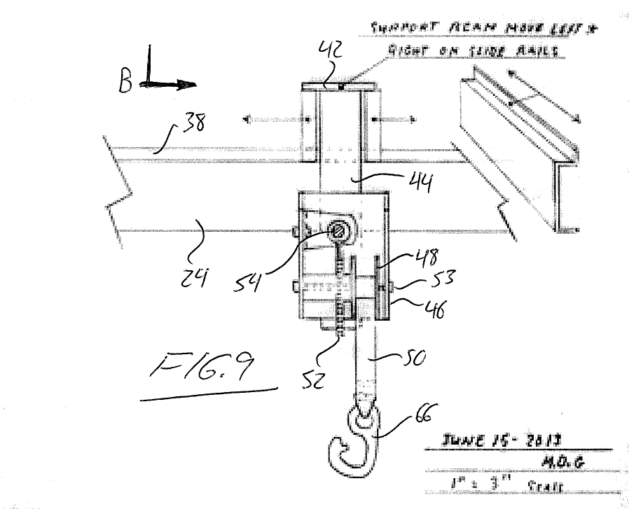

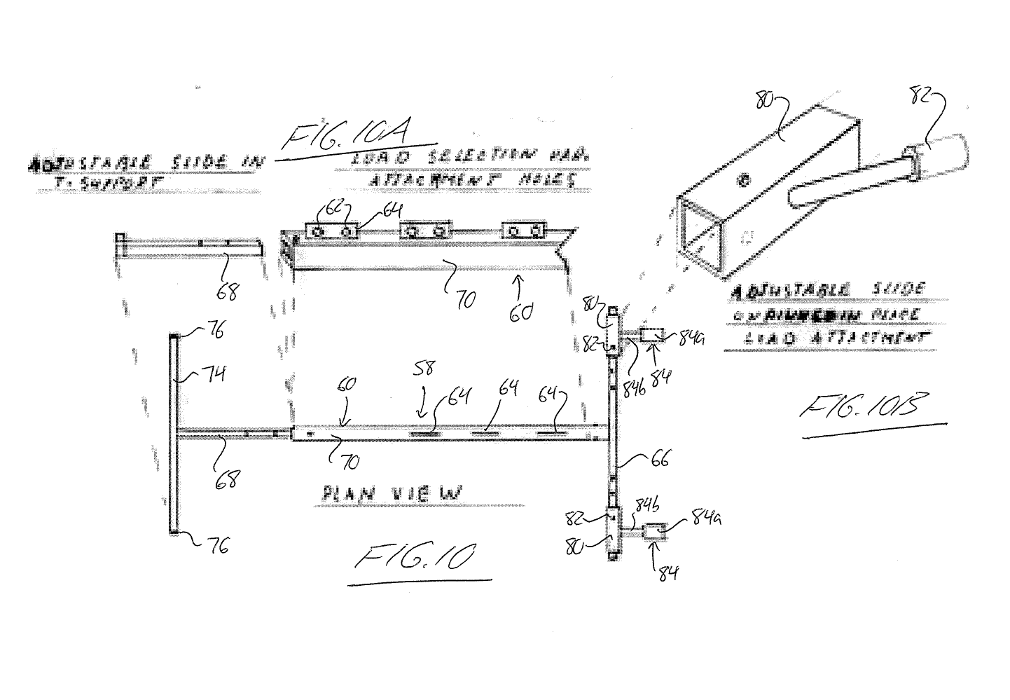

The cross-sectional view of FIG. 8 illustrates a channel-shape for the header beams that integrally provides a horizontal sliding surface for the rails 34 and the blocking flange 38 for same, and illustrates an alternate form of the end piece 36 that not only joins the two rails 34 together, but also depends downward from the rails on the outside of the header beam to jut into an open face thereof beneath the sliding surface so as to positively retain the track assembly on the header beams by preventing lifting of the track assembly from off the header.

A T-shaped carrier unit 40 has a flat horizontal plate 42 lying atop the two rails 34 in a manner spanning thereacross, and a stem 44 that depends perpendicularly downward from the flat horizontal plate 42 between the two rails 34 in order to reach a distance downward therepast. A support bracket 46 projects horizontally rearward from the stem 44 at a position spaced below the rails 34, and rotably carries a winch or hoist drum 48 around which is wrapped a flexible strap 50 of webbing material having one end attached to the drum 48 for winding and unwinding of the strap 48 onto and from the drum 46 under rotation thereof. The use of a strap of greater width than thickness is intended to reduce a twisting tendency of the hoist line during the lifting process versus use of a rope, wire or cable for same.

A gear 52 is fixed on the same shaft 53 as the drum 48, and a worm shaft 54 meshes with the gear 52 and projects rearward therefrom in the longitudinal direction of the apparatus by a sufficient length to reach rearwardly outward from the space between the upright structures of the two side frames. The distal end of the worm shaft furthest from the gear 52 is suitably configured for engagement thereof by a drill 56, for example via a hexagonally faceted end of the worm shaft. Accordingly, a cordless portable drill, a tool almost certainly in the arsenal of an exercise machine repair and service technician, can be used to drive rotation of the worm shaft in either direction, to thereby drive the winch or hoist in order to effect extension and retraction of the strap from the drum 48 by driven rotation of the gear on the shaft that also rotatably supports the drum on the support bracket of the carrier unit 40.

The top plate 42 of the carrier unit 40 is movable back forth along the rails 34 on which it is slidably disposed, whereby the carrier unit, and thus the hoist or winch assembly supported thereon below the track assembly 32, can be displaced back and forth on the slide assembly in the longitudinal direction of the apparatus. Together with the slidability of the track assembly 32 back and forth in the transverse direction, a gantry system is thus defined that allows movement of the hoist in two different dimensions within the rectangular horizontal area bound by the header assemblies and the upright structures of the side frames. That is, the location of the hoist can be adjusted in both the longitudinal direction and the transverse direction of the apparatus.

FIGS. 1 to 3 show a lift unit 58 carried by the winch strap 50 and configured in a manner well suited for lifting of an elliptical machine, and adjustable in a manner allowing adaptability for use with a variety of different brands and models of elliptical machines. The lifting unit 58 features a main longitudinal member 60, for example as formed from at least one piece of rectangular tubing. With the winch strap 50 in a non-twisted position, thus facing longitudinally of the apparatus due to the winch shaft's orientation in the transverse direction, the longitudinal member 60 lies in a vertical plane parallel to the longitudinal direction of the apparatus.

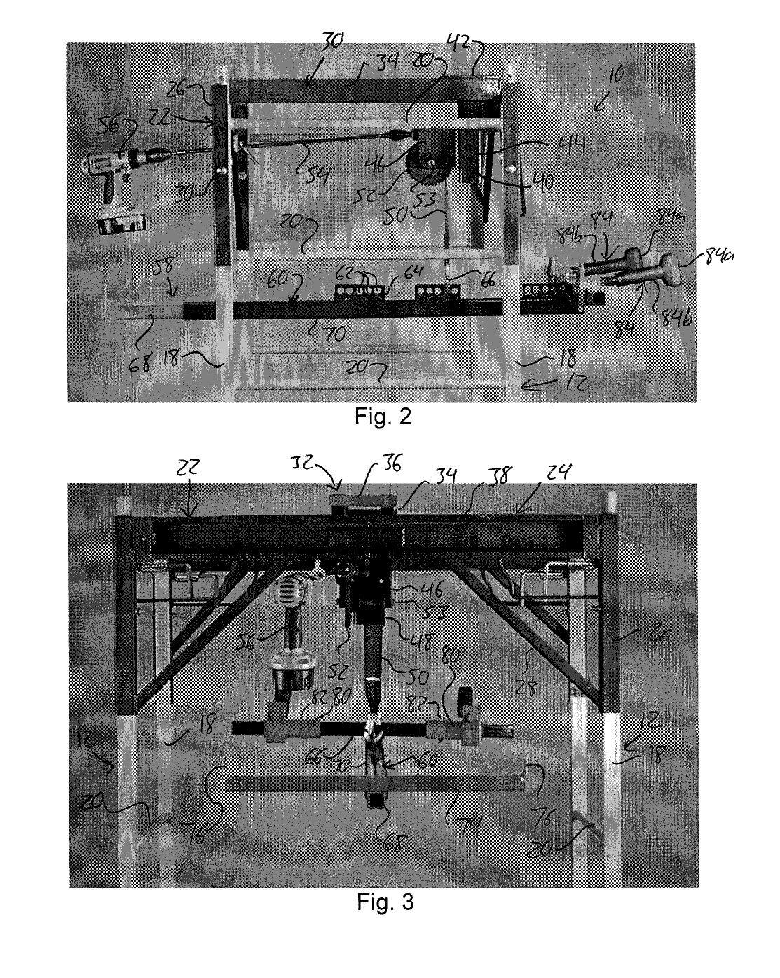

As best seen in FIG. 2, multiple attachment points 62 are provided at spaced-apart locations along the longitudinal member 60 so as to allow selective connection of the longitudinal member 60 to the free end of the winch strap 50 at any one of these different points. In the illustrated embodiment, the attachment points are provided by transverse through-holes 62 provided in one or more vertical-plane flanges 64 projecting upward from the longitudinal member, for example being welded to the topside thereof to project upward therefrom at the central longitudinal plane of the member. A suitable connector, such as a self-closing hook 66, is fixed to the free end of the winch strap and is engagable and disengagable to and from each through-hole 62.

The illustrated longitudinal member 60 is of telescopic, length-adjustable configuration, where an inner piece of tubing 68 is slidably received in an outer piece of tubing 70 having an inner cross-sectional size that slightly exceeds the outer cross-sectional size of the inner piece. Sets of alignable holes in the inner and outer pieces are used to lock the two pieces together in selected telescoped position to set the overall length of the longitudinal member by engagement of a suitable locking pin 72 in a pair of aligned holes in the two pieces.

A free end of the inner piece 68 disposed outside the outer piece is fixed to a rear-end transverse member 74 that lies perpendicular to the longitudinal member 60 to extend toward, without reaching, the vertical planes of the two side frames of the apparatus. An upright flange 76 projects upward from the transverse member 74 at each end thereof.

At an end of the outer longitudinal piece 70 opposite that from which the inner piece 68 extends, another transverse member 78 is fixed to the longitudinal member 60 to likewise lie in the transverse direction between the two side frames, but this front end transverse member 78 lacks the end flanges 76 of the rear end transverse member. Instead, on each side of the longitudinal member 60, a respective sliding sleeve 80 fits over the front transverse member 78 for sliding therealong, back and forth in the transverse direction, toward and away from the longitudinal member 60. Again, a lock pin 82 is used to lock a selected position of the sleeve on the transverse member via alignable holes in the sliding sleeve and the transverse member. A respective lift point member 84 projects forwardly from each sliding sleeve 80 away from the longitudinal member 60, and has a generally T-shaped form, whereby a cross-portion 84a at the free end of the lift point member 84 juts a short distance up and down from the stem portion 84b that projects from the sliding sleeve 80. The lift point members may feature a resilient padding or coating at an exterior thereof to avoid damage to the equipment being lifted, which otherwise might occurs as a result of direct contact with metal or other hard, rigid core material of these members.

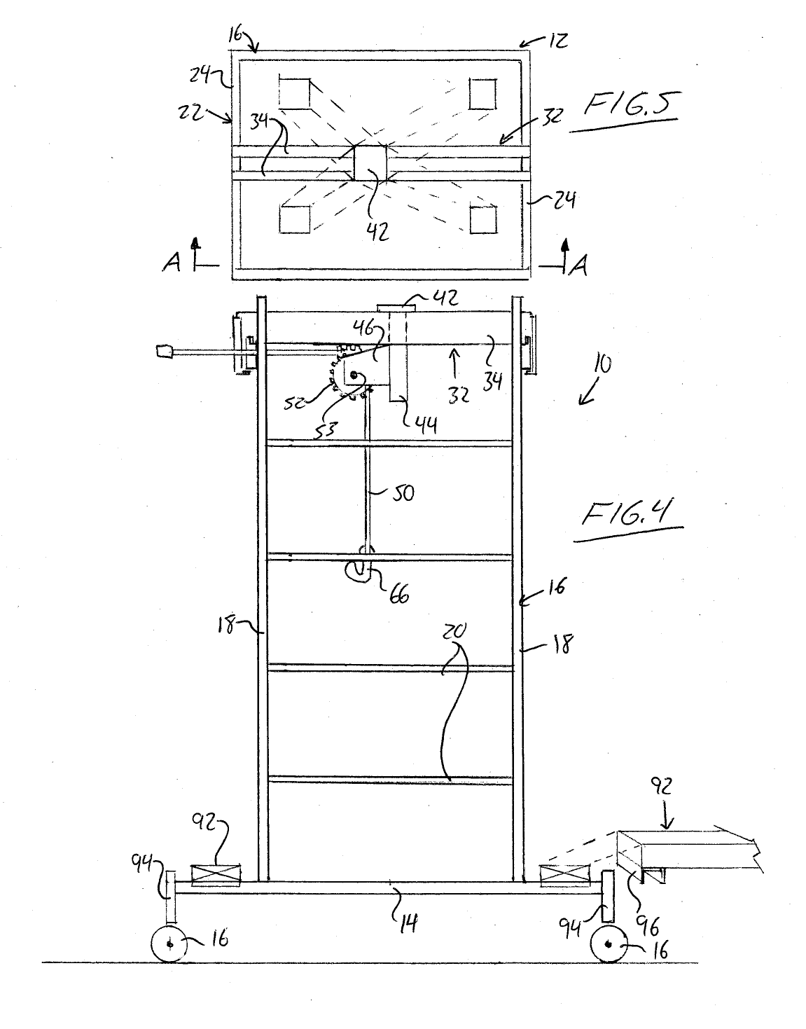

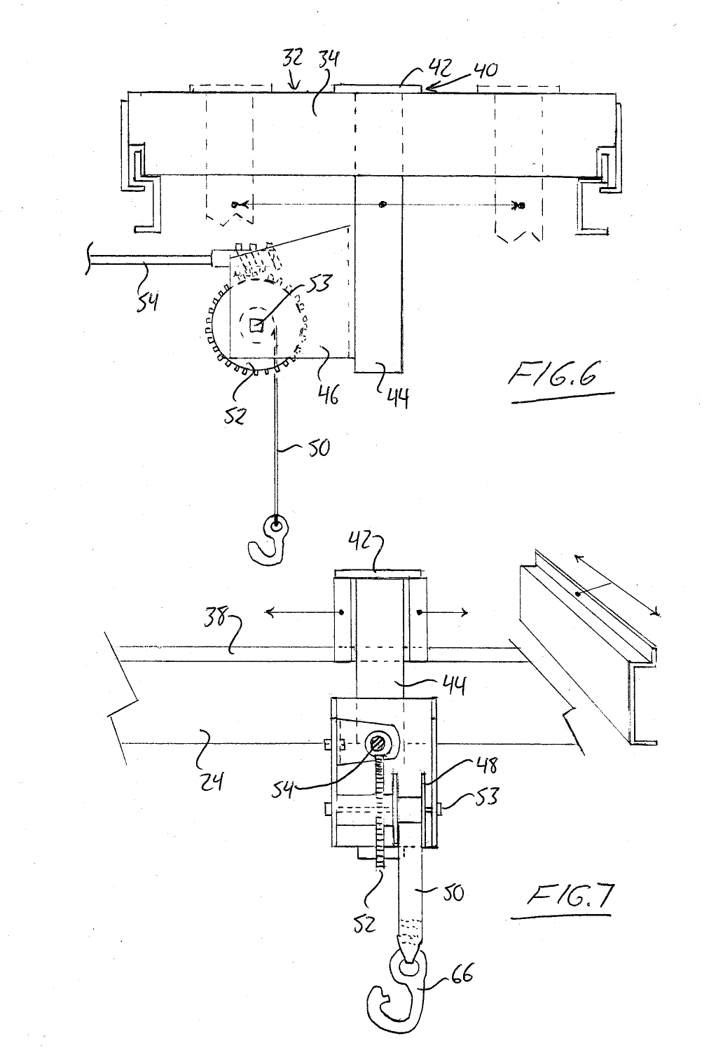

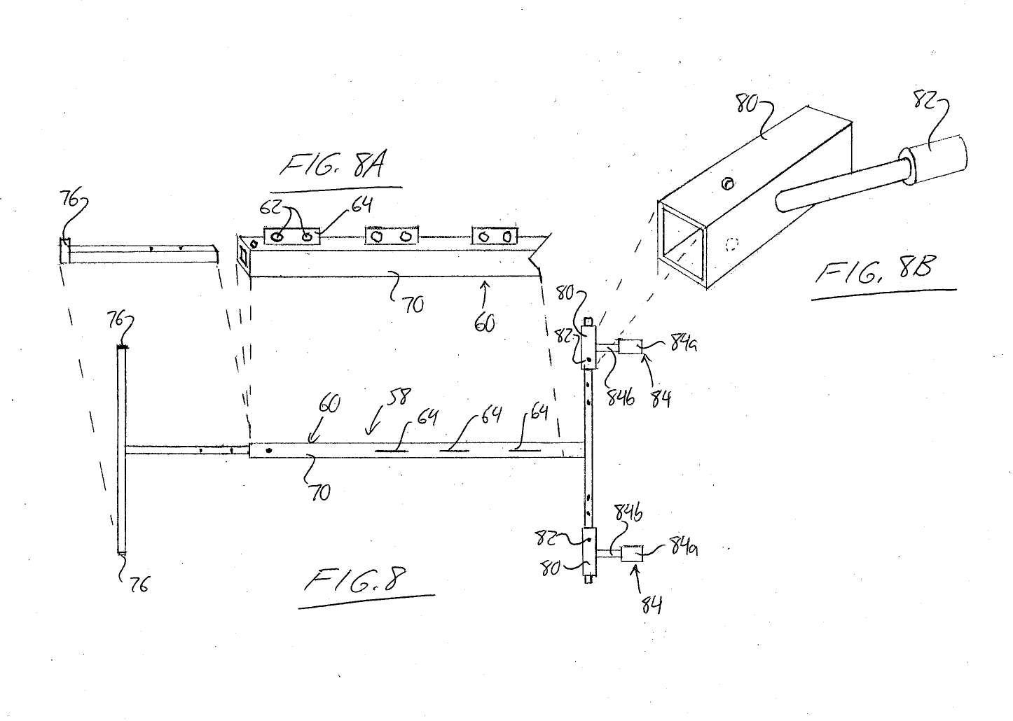

Having described the primary structure of the apparatus, attention is now turned to FIG. 4 where the apparatus is shown in use to transport an elliptical machine 200 out of a position within a row of such machines.

First, the apparatus is rolled, front end first, into a position straddling over the elliptical machine 200 to be pulled from the row of machines. In the figure, the machine 200 is an intermediate machine in the row, and accordingly has another machine disposed to each of its sides. The apparatus is rolled into place in its longitudinal direction so as to move the front end of the apparatus over the machine from the rear end thereof, thus moving each side frame 12 into the available space between the selected machine and the neighbouring machine on a respective side of the selected machine. The header assemblies 22 thus now span overhead of the machine from one side thereof to the other between the two side frames. If needed, the user adjusts the lateral position of the winch by sliding of the track assembly 32 on the cross-beams of the header assemblies in order to place the winch directly overhead of the machine, and may adjust the longitudinal position of the winch by sliding of the winch carrier 40 on the track assembly to an estimated position of the machine's center of mass in the longitudinal direction between the front and rear ends of the machine.

With enough of the strap deployed from the hoist to provide sufficient slack, the lift point members 84 of the lift unit 58 are hooked under the shoulders 202 of the elliptical machine at which the hand operated arm levers 204 of the machine are pivotally connected to the frame of the machine near the front end thereof at which the operator control panel 206 of the machine is disposed. These shoulder features of the machine provide suitable front-end lift points for the machine on either side thereof.

With the lift point members 84 so positioned, the length of the lift unit 60 is telescopically adjusted, if required, in order to position the rear transverse member 74 near the far rear end of the machine. A cradle unit 86 is attached to the rear transverse member 74 in the form of a pair of slings 88 that are each suspended from a respective end of the transverse member just inside the respective end flange 76 thereof and a lift plate 90 that spans between the slings 88 in a direction parallel to the transverse member 74 from which they hang. The plate 90 is inserted under a base of the elliptical machine 200 at the rear end thereof, which is typically defined by the flywheel housing 208 of the machine 200. The winch is driven in the lifting direction, thus raising the lift unit 60, during which the lift point members 84 pull up on the shoulders of the machine 200 near the front of the machine while the cradle 86 pulls up on the rear end of the machine, thus eventually lifting each end thereof once the strap has been tensioned by the retracting of the winch.

If the ends of the machine are being raised unevenly, the winch can be loosened in order to lower any raised part of the machine back to the floor for subsequent adjustment of the winch position and/or the connection point between the winch strap and the lifting unit in order to place the lifting force more optimally in relation to the center of mass of the machine for a subsequent lift attempt.

Once a well-balanced lifting action has been achieved, the machine is lifted to an elevation clearing the base members 14 of the two side frames, at which time a pair of transverse support members 92 are each placed in a position spanning transversely from the base member 14 of one side frame to the base member of the other side frame. In the illustrated embodiment, each support member 92 is placed adjacent a respective end of the base members, i.e. at a location outside of the area straddled by the upright structures and the header therebetween, where a short upright stub 94 is fixed to each end of each base member 14 to form a respective stop to prevent sliding of the respective support member 92 off the base member. A downturned flange 96 at each end of each support member 92 catches over the outward facing side of the respective base member 14 in order to block transverse sliding of the support member. Using the hoist of the apparatus, the lifted machine 200 is then lowered onto these support members for stable seating of the machine thereatop. This way, the hoist is not being relied upon during transport of the machine to another location by rolling of the apparatus off of the exercise floor. Accordingly, the machine cannot swing or swivel during transport.

The apparatus is then rolled back or forward in the longitudinal direction in order to move the supported machine 200 out of the row of machines, and then rolled to the desired location off the exercise floor for the required service, repair, maintenance, or other purpose.

FIG. 5 shows use of the apparatus to lift and transport a treadmill machine 300. Here the apparatus is being used to move an end-machine in the row of side-by-side machines, and accordingly only one of the two side frames is disposed between two adjacent machines during the lifting process. FIG. 5 shows a lift unit 100 of different form than that described above for an elliptical machine. The details of this lift unit 100, which can be readily interchanged for the elliptical lift unit 58, can be seen in FIG. 1, where the treadmill lift unit 100 is shown disconnected from the winch and seated on one of the transverse support members 92.

The treadmill lift unit 100 features no longitudinal member, instead having only a single transverse member 102, which may be of a telescopic form having two inner pieces 104 each slidably disposed within a respective end of a tubular outer piece 106. A suitable winch-strap attachment flange 64′ is provided at a central location along this outer piece of tubing 106 for connection of the winch strap hook thereto. The transverse member lies in the transverse direction directly below the winch strap 50 during use, and the length of the transverse member may be adjusted by extending and retracting the inner pieces 104 and locking the selected length of the transverse member by use of lock pins 108 in alignable holes among the inner and outer pieces.

With reference to FIG. 5, each end of the transverse member 102 of the treadmill lifting unit 100 is inserted under a respective handle extension 302 of the treadmill 300 that extends rearwardly from the control panel 304 at the front end of the machine to form a manually grippable handle available to a user of the machine while walking or running on the revolving belt of the treadmill deck. Particularly, the illustrated embodiment features insertion of each end of the lifting unit 100 respectively into the corner defined between one of the handles 302 of the machine 300 and an angled upright support 306 that extends upward from a base of the treadmill to the handle 302 in order to provide adequate support of the same. A bungee cord, rubber tie down, or other stretchable or length-adjustable flexible strap or tie 110 is hooked to each of the lifting unit 100 where the same juts slightly out from under the handle of the machine, whereby the strap or tie extends snugly around the two handle supports 306 of the machine in order to form a confident lifting harness for the machine. Using such an arrangement, safe lifting of the treadmill is possible from this single intermediate location along the machine's longitudinal dimension. The treadmill can thus be lifted without separate lift points at multiple points along its length, unlike the above-described lifting of an elliptical machine at its two opposing ends.

The lifting and transport of the treadmill is otherwise identical or similar to the process described for the elliptical machine. As a motor-driven machine, unlike a resistance-based machine such as the described elliptical trainer, a treadmill will often feature a notably unbalanced weight distribution in the transverse direction due to the placement of the drive motor off to one side of the longitudinal center plane of the machine. However, with the two-dimensional adjustability of the winch location via the gantry mechanism of the lift apparatus, the technician can easily accommodate this offset center of mass of the machine, and perform a safe, balanced lifting of same by offsetting the winch position more toward the side frame of the apparatus that resides on the side of the machine opposite the motor's position.

In summary of the illustrated embodiment, the lifting apparatus, which may be marketed as the Cardio Crane due to its particular usefulness in moving bulky cardio workout equipment, provides a safe way for one person to transport pieces of equipment. This device is designed to make it easier for anyone who maintains and cleans sports equipment to get the heavy machine into the workshop without getting injured in the process. The disclosed apparatus visually resembles a small section of scaffolding with a gantry hoist at the top that moves left or right and front to back to accommodate for the center of gravity of different equipment. This allows the user to make sure the elliptical machine or treadmill is lifted in a balanced and safe manner. The invention is on wheels, so the sports equipment can easily be rolled to the repair location.

Cardio Crane allows users to transport heavy sports equipment off the exercise floor for repair. The illustrated embodiment comprises a relatively simple structure, with only four main frame components, notably two adjustable side frames with wheel casters on the bottom and two header beams that connect the side frames securely together. The header beams support the gantry lift that is able to move left or right and front to back in order to accommodate different equipment's center of gravity so that the lifting of the equipment can be well-balanced and safely performed. There may be two or more different interchangeable lift bar assemblies, which may be referred to as spreader bars due to the described adjustability of the illustrated embodiments to spread or expand in one or more dimension. The illustrated lift bar assemblies can pick up a variety of elliptical and treadmills safely and without damaging the equipment, simply by hooking the lift bar unit under suitable pick-up points on the exercise machine, which may vary from those described.

The apparatus may be configured to have a height less than 7-feet, a length less than 6-feet, and a width less than 4 feet so as to conveniently fit between machines arranged in a row of conventional inter-machine spacing and to easily fit into a standard passenger elevator. For example, in one particular embodiment, the apparatus may measure approximately 74″ high, 52″ long and 44″ wide. As described, the height of the header beams may be adjustable to achieve a balance between accommodating different machine heights, while not interfering with standard ceiling and doorway heights during transport.

The lift bars of the illustrated embodiment may be lowered using an 18-volt cordless drill hooked up to a worm drive winch. The cardio equipment can then be lifted off the ground by a suitable amount, for example 2-feet, in order to accommodate placement of the support plates or bars under the base of the equipment. The machine can then be lowered down on the support bars for safety so it doesn't swing while the apparatus and lifted equipment are in transit. The Cardio Crane can also be instrumental in lowering the equipment in need of service onto a platform or hydraulic work table so the repair work does not have to take place on the floor, therefore dramatically improving the repair process and comfort for the service person. The illustrated embodiment employs a structure formed primarily of rectangular metal tubing and metal beams or channels, but it will be appreciated that exact specifications, materials used, and method of use of Cardio Crane may vary within the scope of the present invention.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. Apparatus for lifting and transporting exercise equipment, the apparatus comprising:
a pair of side frames each comprising wheels at a bottom thereof;
a header joining together the pair of side frames;
a winch supported by the header for lifting of said exercise equipment.

2. The apparatus of claim 1 wherein the winch is supported on the header in a manner movable in both side-to-side and front-to-back directions to accommodate varying center-of-gravity locations of different pieces of exercise equipment to enable balanced lifting of said different pieces of exercise equipment.

3. The apparatus of any claim 1 comprising supports for placement under the exercise equipment when lifted for lowering of the exercise equipment onto the supports to prevent swinging of the exercise equipment during transit.

4. The apparatus of claim 1 comprising interchangeable lift units lowerable by the winch and positionable under lift points of different types of exercise equipment for lifting thereof.

5. The apparatus of claim 1 comprising a lift unit lowerable by the winch and positionable under lift points the piece of exercise equipment for lifting thereof, wherein the lift unit comprises a longitudinal lift member, .front and rear transverse lift member's lying perpendicular to the longitudinal lift member, lift point members projecting longitudinally from the front transverse lift member to extend away from the longitudinal lift member on opposing sides thereof and a cradle unit attached to the rear transverse member for engagement of a lower end of said cradle unit under a rear end of the exercise equipment to suspend said rear end of the exercise equipment from said rear transverse member.

6. The apparatus claim 5 wherein the longitudinal lift member comprises a series of different attachment points spaced therealong for selective connection of the winch to the longitudinal member at any of said attachment points.

7. The apparatus of claim 1 wherein the winch is supported on the header in a manner movable in both side-to-side and front-to-back directions, each side frame comprises an elongated base running defining a longitudinal front to back direction of the apparatus and the wheels of each side frame are attached to the elongated base of said side frame at spaced apart positions along the longitudinal front to back direction of the apparatus, the header comprises header beams defining a lateral side-to-side direction of the apparatus and spacing the side frames horizontally apart in said lateral side-to-side direction, and the apparatus is rollable in the longitudinal direction on the wheels to place the side frames on opposing sides of the exercise equipment with the header beams spanning over the exercise equipment in the lateral direction to place the winch overhead of the exercise equipment, whereby a location of the winch in relation to the center of gravity is adjustable in the longitudinal direction by both rolling of the apparatus and movement of the winch in said the longitudinal direction and adjustable in the lateral direction by movement of the winch in said lateral side-to-side direction.

8. The apparatus of claim 1 comprising a carrier member on which the winch is mounted, the carrier member being movably supported on an elongated track extending in either the front-to-back or side-to-side direction for back and forth movement of said carrier member along the elongated track, and the elongated track being movable back and forth relative to the side frames in the other of the front-to-back or side-to-side direction.

9. The apparatus of claim 1 comprising a flexible strap operably wrapped on the winch for deployment and retraction of said flexible strap by the winch.

10. The apparatus of any one of claim 1 wherein the winch is adapted for driven operation thereof by a portable electric drill.

11. A method of lifting and transporting a selected piece of exercise equipment from among a row of multiple pieces of exercise equipment placed side by side on the ground or floor of an exercise site, the method comprising:
(a) rolling a lift apparatus into a position straddling said selected piece of exercise equipment with two side frames of said lift apparatus on opposing sides of said selected piece of exercise equipment and a header of said lift apparatus spanning over said selected piece of exercise equipment from one of said side frames to the other;
(b) using a winch carried by said header of the lift apparatus, lifting the selected piece of exercise equipment off of the ground or floor from overhead of said selected piece of exercise equipment; and
(c) with the selected piece of exercise equipment supported by said lift apparatus at a position between the side frames of the apparatus and above the ground or floor of the exercise site, rolling the lift apparatus out of a position from which the selected piece of exercise equipment was lifted so as to withdraw said selected piece of exercise equipment from the row of said multiple pieces of exercise equipment.

12. The method of claim 11 wherein step (b) first comprises adjusting a location of the winch relative to the side frames toward a center of gravity of the selected piece of exercise equipment before lifting thereof.

13. The method of claim 12 wherein step (b) comprises adjusting the location of the winch in two horizontal dimensions.

14. The method of claim 11 comprising changing a type of exercise equipment the apparatus is adapted to lift by swapping out one style of lifting unit suspended from the winch for another style of lifting unit.

15. The method of claim 11 wherein step (b) comprises lifting the selected piece of exercise equipment with a lifting unit that is carried by the winch and engages the selected piece of exercise equipment adjacent two longitudinally opposing ends thereof.

16. The method of claim 11 wherein step (b) comprises lifting the selected piece of exercise equipment with a lifting unit that is carried by the winch and engages the selected piece of exercise equipment only at a longitudinally intermediate location thereon.

17. The method of claim 15 wherein step (b) comprises hooking two lift point members of said lifting unit beneath a pair of shoulders adjacent a front end of an elliptical machine at which arm levers of the elliptical machine are pivotally connected, and engaging a cradle member of said lifting unit around an opposing rear end of elliptical machine.

18. The method of claim 16 wherein step (b) comprises hooking a transverse bar of the lifting unit under each of two handles of a treadmill machine at respective corners where said handles join to respective upright handle supports that extend upward from a base of said treadmill machine.

19. The method of claim 18 wherein step (b) comprises securing a flexible tie around said upright handle supports from adjacent opposing ends of the transverse bar of the lifting unit.

20. The method of claim 11 wherein step (b) comprises, with the selected piece of exercise equipment lifted, placing transverse supports in positions spanning between the two side frames beneath the selected piece of exercise equipment, and lowering said selected piece of exercise equipment into a seated position on said transverse supports for seated, rather than hanging, support of the exercise equipment during transit in step (c).
